(19) United States
(12) Patent Application Publication
(10) Pub. No.: US 2005/0037134 A1
(43) Pub. Date: Feb. 17, 2005

(54) Process of manufacturing micronized oxide cathode

(75) Inventors: Mei Liu, Pingtung Hsien (TW); Chi Neng Mo, Chungli City (TW); Pei Kuang Lin, Taipei Hsien (TW); Li-Na Chang, Pate City (TW); Yung Wei Yang, Taipei (TW)

Correspondence Address: Jianq Chyun Intellectual Property Ofice, 7F.-1, No. 100 Roosevelt Rd, Sec 2, Taipei 100, TW

(73) Assignee: CHUNGHWA PICTURE TUBES, LTD., Taipei (TW)

(21) Appl. No.: 10/641,225

(22) Filed: Aug. 12, 2003

(51) Int. Cl. B05D 5/12

(52) U.S. Cl. 427/58; 427/372.2; 427/402

(57) ABSTRACT

The invention relates to a process of manufacturing micronized oxide cathode comprising the steps of performing a micronized attrition on a cathode material for oxide cathode manufacture in order to decrease an average diameter of particles of a conventional cathode material from the order of micron (e.g., about 2.0 μm) to the order of sub-micron (e.g., about 0.09 μm to 1 μm), coating the cathode material on a cathode substrate, and heating the cathode substrate in a vacuum environment for producing a micronized oxide cathode able to increase the area of hot electron emission on the surface thereof, increase the pore conduction mechanism on the oxide, and effectively improve the hot electron emission properties of the oxide cathode.

### FIELD OF THE INVENTION

The present invention relates to processes of manufacturing oxide cathode and more particularly to such a process of manufacturing micronized oxide cathode with improved characteristics.

### BACKGROUND OF THE INVENTION

Since Wehnelt found that alkaline earth oxides can be used as material in manufacturing cathodes for emitting effective hot electron in 1904, the characteristics of an oxide cathode are intensively studied. Moreover, oxide cathodes are widely used in many applications such as hot electron cathodes. For hot electron cathodes used in cathode ray tube (CRT) manufacturing processes, the hot electron cathode comprises an oxide cathode, a submerged cathode, and a scandia cathode in which the oxide cathode is the most widely used material as hot electron emission source in the electronics industry due to its advantages such as low material cost, easy manufacturing, and stable properties. As shown in FIG. 1 a conventional process of manufacturing oxide cathode comprising coating material of carbonate (e.g., BaCO₃, SrCO₃, and CaCO₃) 2 on a nickel alloy substrate 1 containing less than 10 ppm of reducing agent (e.g., Mg, Si, and Al), heating the nickel alloy substrate 1 at a temperature about 800° C. in a vacuum environment by means of a heating element 3. dissolving the carbonate 2 into barium oxide, (strontium oxide or calcium oxide) and carbon dioxide, and acting a portion of barium oxide with reducing agent in the nickel alloy substrate 1 for producing ionized barium. As an end, oxide cathodes are produced, wherein the ingredients contained in the conventional oxide cathode, such as strontium oxide (SrO) and carbon oxide (CaO), are adapted to bond the ionized barium for preventing it from depleting due to excessive evaporation.

With respect to conventional oxide cathode, Beynar and Nikonor then proposed a barium atom layer mode for estimating the efficiency of hot electron emission by means of Richardson formula (1) as below:
J=AT²exp(−eφ/KT), φ=φ₀+αT (1)
where A=120.4 A/cm²K²; φ is power function; φ is power function at 0⁰K ; and α, is temperature coefficient. The power function of φcan be decreased and the efficiency of hot electron emission can be increased by doping alkaline earth metals.

With respect to the efficiency of hot electron emission in conventional oxide cathode, Loosjer and Vink found a pore conduction mechanism in oxide of the oxide cathode after considerable research and experimentation, and concluded the pore conduction mechanism is an important factor in affecting the efficiency of hot electron emission. In addition, Rutter found a technique of coating nickel on the substrate of oxide cathode in 1979. Saito found a technique of doping scandium oxide in oxide cathode and sputtering tungsten film on nickel alloy substrate for improving the properties of the hot electron cathode in 1986 and 1996. All of these researches had a significant meaning in improving characteristics of hot electron cathode.

In recent years, there is an increasing demand for high picture quality and high brightness of projection TV among vast consumers. As such, how to produce projection TVs having benefits of inexpensive, clear picture, and high brightness is the most important goal among major projection TV manufacturers. Typically, there are many factors in affecting projection TV's picture quality and brightness in which for a projection TV incorporating CRT, picture and brightness generated by red (R), green(G), and blue (B) monochromic CRTs are the most important ones in either directly or indirectly affecting TV's picture quality and brightness.

For solving problems of poor picture quality and insufficient brightness in the conventional projection TVs, a solution proposed by designers and manufacturers of the conventional projection TVs is characterized in increasing the current of electron emission source (e.g., cathode) of each monochromic CRT. This has benefits of generating beams of high energy, significantly increasing screen brightness produced by electrons emitted from the monochromic CRTs, and improving picture quality, brightness, and hue of projection TVs. However, the number of electrons in a single beam will increase significantly duo to increasing current of the single electron emission source of each monochromic CRT. This can gradually increase the section of the beam toward screen of each monochromic CRT due to the increasing repelling force of charges. To the worse, halo may occur. Though such effect can be slightly improved by modifying focusing lens or common lens of electron gun of each monochromic CRT or increasing or enlarging diameter of tube neck of each monochromic CRT, it unfortunately will greatly increase manufacturing cost and complicacy of manufacturing processes.

Thus, it is desirable to provide a novel oxide cathode which can be used to manufacture CRTs of high picture quality and high brightness without greatly increasing manufacturing cost and modifying the existing equipment and manufacturing process.

### SUMMARY OF THE INVENTION

A primary object of the present invention is to provide a process of manufacturing a micronized oxide cathode comprising the steps of performing a micronized attrition on a cathode material for oxide cathode manufacture in order to decrease an average diameter of particles of the cathode material from the order of micron (e.g., about 2.0 μm) as experienced in the prior art to the order of sub-micron (e.g., about 0.09 μm to 1 μm) as carried out by the present invention, and producing the oxide cathode of the present invention from the micronized cathode material. The micronized oxide cathode of the present invention can effectively improve an efficiency of hot electron emission of the oxide cathode.

One object of the present invention is to perform an attrition on at least one micronized cathode material such as carbonate containing barium by means of nano attrition technology, coat the micronized cathode material on a cathode substrate, and heat the cathode substrate in a vacuum environment to produce the finished oxide cathode. The micronized oxide cathode of the present invention can significantly increase area of hot electron emission of the oxide cathode and improve pore conduction mechanism in the oxide of the oxide cathode.

Another object of the present invention is to sequentially, evenly coat each micronized cathode material on the substrate for forming an oxide cathode having a hierarchical structure. The micronized oxide cathode of the present invention can effectively improve efficiency of hot electron emission of the oxide cathode by incorporating different properties of cathode materials.

Still another object of the present invention is to perform an attrition on a cathode material to form required micronized particles by means of nano attrition technology. High current emission density and efficiency of hot electron emission of the micronized oxide cathode of the present invention are substantially the same as that of strontium oxide cathode. Moreover, quality control of the manufacturing processes is better than that of the well known oxide cathode or strontium oxide cathode.

The above and other objects, features and advantages of the present invention will become apparent from the following detailed description taken with the accompanying drawings.

### BRIEF DESCRIPTION OF THE DRAWINGS

FIG. 1 is a sectional view of a conventional cathode;

FIG. 2 is a graph illustrating the distribution of measured diameters of particles of the conventional cathode material;

FIGS. 3(a) and 3(b) schematically depict air exhaust effects of cathode material having particles of small diameter and large diameter respectively;

FIG. 4 is a graph illustrating the distribution of measured diameters of particles of cathode material being worn down by attrition by nano attrition technology according to a preferred embodiment of the invention;

FIGS. 5(a) and 5(b) are photographs illustrating surface flatness of the cathode coated on a cathode substrate before and after performing attrition respectively;

FIG. 6 is a sectional view of an oxide cathode manufactured according to a process of preferred embodiment of the invention;

FIGS. 7(a), 7(b), 7(c), and 7(d) are sectional views of an oxide cathode manufactured according to processes of other preferred embodiments of the invention;

FIGS. 8(a), 8(b), 8(c), 8(d), and 8(e) are sectional views of an oxide cathode manufactured according to processes of still other preferred embodiments of the invention;

FIGS. 9(a), 9(b), and 9(c) are photographs illustrating R, G, and B electronic guns which have been tested by CC (cathode condition) in a 15″ color CRT of second test cathode (i.e., hₙ=35 μm) incorporated according to the invention;

FIGS. 9(a), 9(b), and 10(c) are photographs illustrating R, G, and B electronic guns which have been tested by CC (cathode condition) in a 15″ color CRT of second test cathode (i.e., hᵣ=70 μm) incorporated according to the invention; and

FIG. 11 is a graph comparing a limit curve with an experiment curve in a thermal strain test of the second test cathode (i.e., hₙ=35 μm) according to the invention.

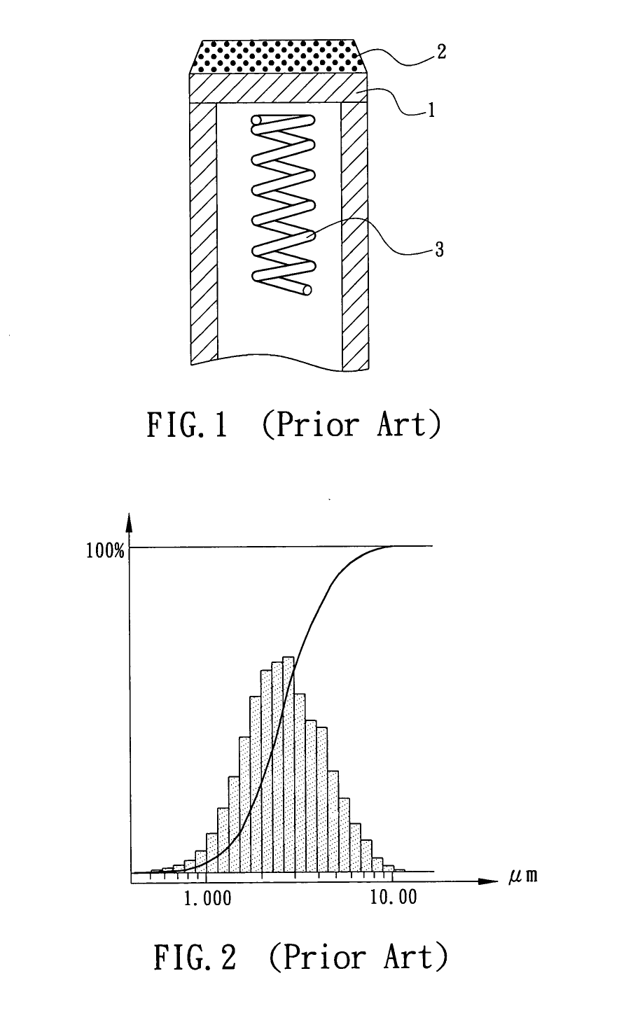

### DETAILED DESCRIPTION OF THE PREFERRED EMBODIMENTS

The invention is directed to a process of manufacturing micronized oxide cathode comprising the steps of performing a micronized attrition on a cathode material for oxide cathode manufacture in order to decrease an average diameter of particles of the cathode material from the order of micron (e.g., about 2.0 μm) as experienced in the prior art to the order of sub-micron (e.g., about 0.09 μm to 1 μm) as carried out by the invention, coating the cathode material on a cathode substrate, and heating the cathode substrate in a vacuum environment. As an end, the oxide cathode of the invention is produced. The oxide cathode of the invention has advantages of increasing the area of hot electron emission on the surface of the oxide cathode, increasing the pore conduction mechanism on the oxide, and effectively improving the hot electron emission properties of the oxide cathode.

The well known oxide cathode, as a part of the CRT, is formed of cathode material containing carbonate (e.g., BaCO₃, SrCO₃, and CaCO₃). An average diameter of the cathode material particles is about several microns. As shown in FIG. 2, a graph illustrating the distribution of measured diameters of particles of the well known cathode material, the distribution of diameters of particles is from 1.18 μm to 6.03 μm (D₅ to D₉₅). The average diameter is about 2.6 μm (D₅₀). A distribution deviation is 4.85 μm (D₉₅−D₅=4.85 μm). According to the above theory proposed by Loosjer and Vink, hot electrons in the electron cloud can be accelerated to hit molecules of oxide by applying electric field into pores in oxide. As a result, second electron emission can be generated for increasing its current density. In view of this, the inventor contemplates that the pore density of the oxide cathode can be increased several times if the diameter of particle (or powder) of the cathode material is decreased several times. As a result, the generation of second electron emission can be improved significantly.

Heretofore, there is no disclosure of theory substantially close to the real pore model of oxide. But the inventor contemplates that theory of particle arrangement can be adopted to understand the increase of pore density. Based on the theory of particle arrangement, it is assumed that a plurality of cathode material particles having a particle diameter of d are stacked to form a body having diameter D and height h in which a group of pores comprise 8 particles. Further, the following formula (2) can be used to calculate the number of pores N_{porosity}:

$${N}_{porosity} = \frac{1}{8} * \frac{\frac{1}{4} π {D}^{2} h}{\frac{4}{3} π {d}^{3}} = \frac{3}{128} * \frac{{D}^{2} h}{{d}^{3}} \qquad ( 2 )$$

It is seen that the number of pores N_{porosity} and thus the efficiency of the second electron emission will increase as the particle diameter d of the cathode material decreases.

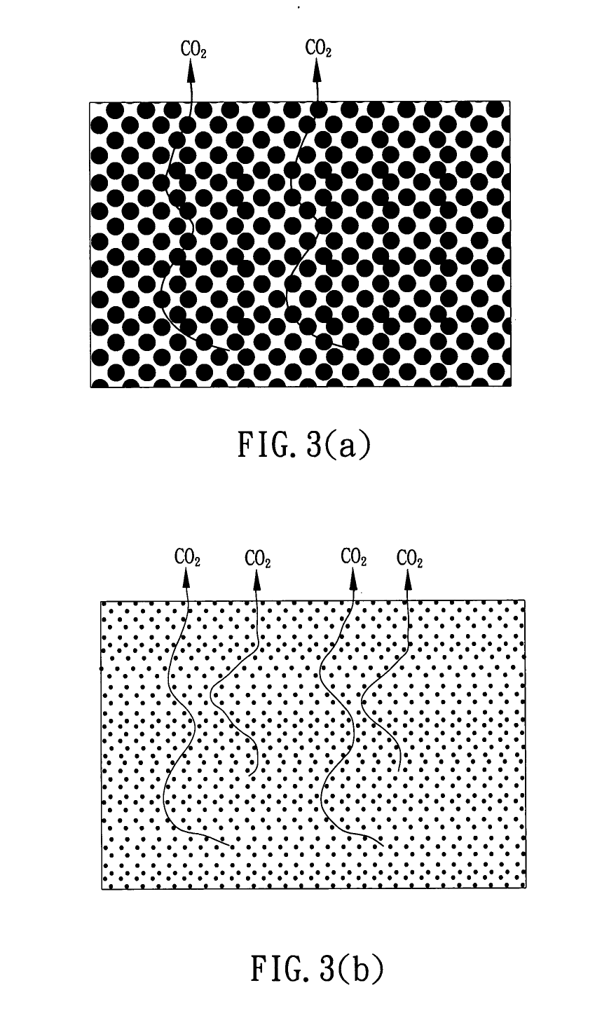

Moreover, the carbonate component in the cathode material will be dissolved or acted with the reducing agent in the substrate due to heat in the cathode activation process, and will generate CO₂ based on the following formula (3):
at 1100°K, BaCO₃→BaO+CO₂← (3)
At this time, a pumping station must be activated to draw out CO₂. Otherwise, an excessive high pressure of CO₂ will create a eutectic compound 2BaCO₃:BaO, resulting in a cathode coating fuse and an increase of crystalline. To the worse, the eutectic compound not only sinters and fuses the coating of oxide cathode, but also degrades porosity and increases resistance (i.e., significant voltage drop as current flows). Still to the worse, the efficiency of hot electron emission will be decreased due to the weakened electric field. For solving this problem, it is proposed to increase the porosity of oxide cathode and thus increase the escape efficiency of CO₂. As shown in FIGS. 3(a) and 3(b), the escape efficiency of CO₂ of the particles having a small diameter (see FIG. 3(a)) is higher than that of the particles having a large diameter (see FIG. 3(b)). Thus, the inventor concludes that an increase of the number of pores in oxide cathode will improve the reaction of the hot cathode.

In view of the above, the inventor proposes to perform an attrition on the well known cathode material powder (or particles) having a diameter of 2.6 μm to form one having a diameter of 0.09 μm to 1 μm (D₅₀) and a diameter difference of the cathode material particles is from 0.25 μm to 0.55 μm (D₉₅-D₅=0.25 μm to 0.55 μm) by performing a nano powder attrition in which solid content is still maintained at 25% to 55%. Then, through the experimentation, the Optoelectronic properties thereof can be observed and the particle diameter can also be selected. In a preferred embodiment of the invention, the inventor selects a particle having an average diameter about 0.455 μm as an example as detailed below.

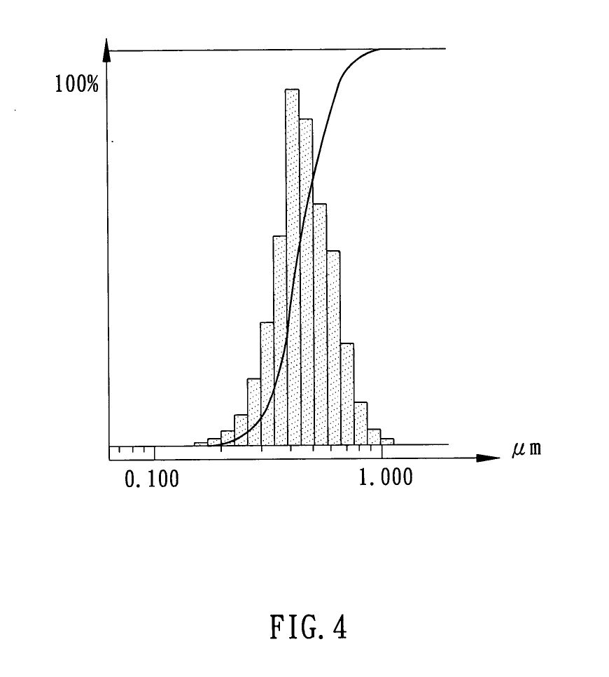

FIG. 4 is a graph illustrating the distribution of measured diameters of particles of cathode material being worn down by attrition. The cathode particles are distributed between 0.278 μm to 0.740 μm (D₅ to D₉₅) after performing the attrition. Further, an average diameter is about 0.455 μm (D₅₀). A distribution deviation is 0.462 μm (D₉₅−D₅=0.462 μm) in which the solid content is maintained at about 40%.

The inventor finds the following differences by comparing the diameters of the well known cathode material particles before and after performing an attrition:

| Diameter | before attrition | after attrition |
|---|---|---|
| (1) average diameter of | 2.60 μm | 0.455 μm |
| cathode material particles (D₅₀) | | |
| (2) minimum diameter (D₅) | 1.18 μm | 0.278 μm |
| (3) maximum diameter (D₉₅) | 6.03 μm | 0.740 μm |
| (4) diameter difference (D₉₅-D₅) | 4.85 μm | 0.462 μm |

(1) Comparison of average diameter: The average diameter of the well known cathode material particles before attrition is about 5.7 times of that after attrition. Through the application of formula (2), it is found that the number of pores in oxide cathode formed of the cathode material after being worn down by attrition is 185 times (5.7³≈185) as that of the well known oxide cathode formed of the cathode material before being worn down by attrition.

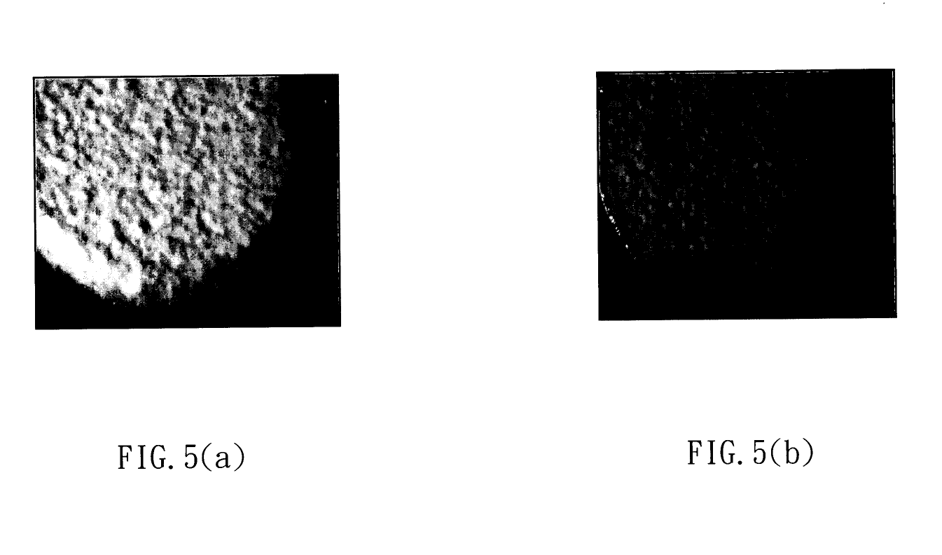

(2) Comparison of distributed diameter: The distributed diameter of the well known cathode material particles before the attrition is 4.85 μm which is about 10.5 times of 0.462 μm as the distributed diameter of the well known cathode material particles after the attrition. The particle diameter is reduced significantly with a relatively high concentration of diameter distribution. As such, a more smooth surface is formed on the oxide cathode after coating the oxide cathode (which has been worn down by attrition) on the cathode substrate surface (see FIG. 5(b)). This is advantageous over that of the well known oxide cathode (see FIG. 5(a)).

In the preferred embodiment, the process of manufacturing micronized oxide cathode at least comprising the following steps:

(1) Performing a micronized attrition on a cathode material for oxide cathode manufacture by performing a nano powder attrition, and micronized the average diameter of particles to about 0.455 μm (D₅₀). Note that the above is only an embodiment of the invention. It is appreciated by those skilled in the art that the invention is not limited by the embodiment. To the contrary, the micronized cathode material as defined by the invention is that one has an average diameter of particles from 0.09 μm to 1 μm (i.e., in the order of sub-micron) after performing a nano powder attrition on any well known cathode material.

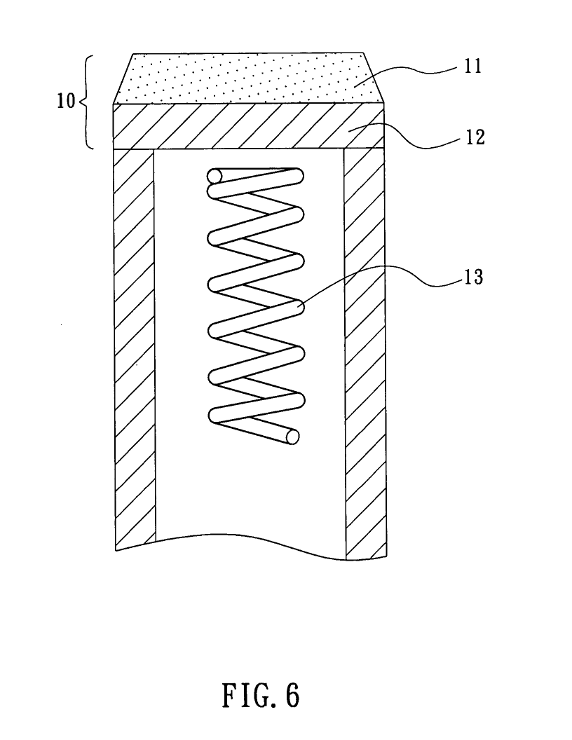

(2) Evenly coating the micronized cathode material 11 on a substrate 12 (see FIG. 6).

(3) Heating the substrate 12 in a vacuum environment by means of a heating element 13 for forming an oxide cathode 10 of the invention.

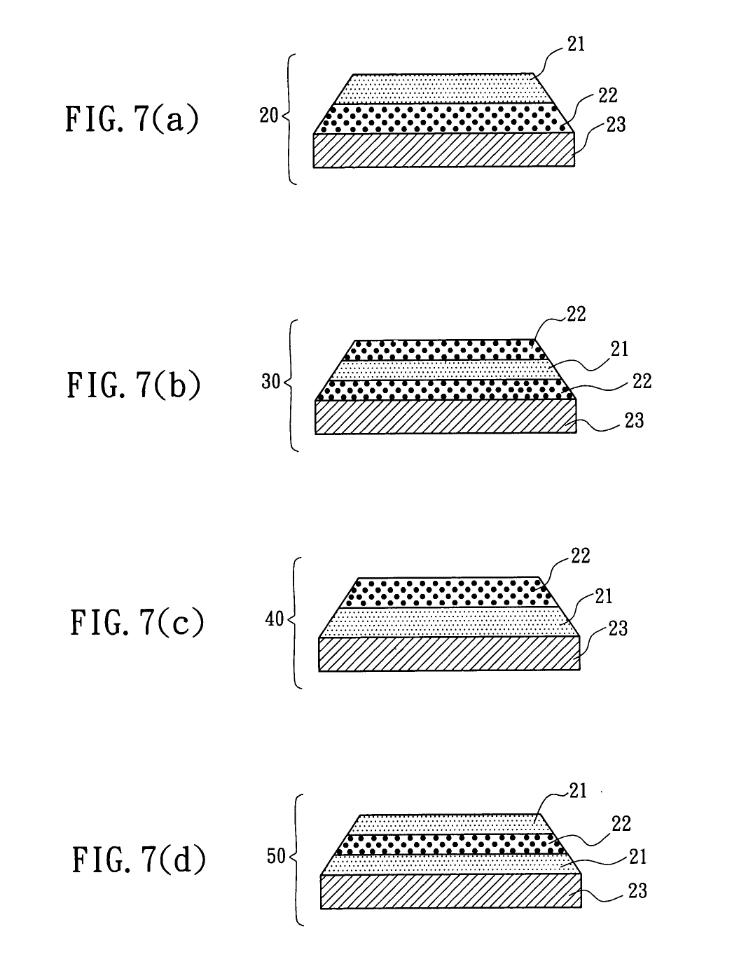

Referring to FIGS. 7(a) to 7(d), other preferred embodiments of the invention are shown. It is possible of sequentially, evenly coating at least one cathode material 21 which has been micronized previously, and a cathode material 22 having at least one well known diameter (having a diameter of at least 1.7 μm, i.e., D₅₀=1.7 μm) on a substrate 23 depending on applications. As a result, an oxide cathode having a hierarchical structure is formed. This can effectively improve efficiency of hot electron emission of the oxide cathode by incorporating different properties of cathode materials. The oxide cathode manufactured by any of the above embodiments comprises four structural characteristics as follows:

(1) As shown in FIG. 7(a), a cathode material 22 having a well known diameter is evenly coated on the substrate 23. Next, a micronized cathode material 21 is evenly coated on the well known cathode material 22 for forming an oxide cathode 20 having at least two layers of cathode material.

(2) As shown in FIG. 7(b), a cathode material 22 having a well known diameter is evenly coated on the substrate 23. Next, a micronized cathode material 21 is evenly coated on the well known cathode material 22. Next, a cathode material 22 having a well known diameter is evenly coated on the micronized cathode material 21 for forming an oxide cathode 30 having at least three layers of cathode material.

(3) As shown in FIG. 7(c), a cathode material 22 having a well known diameter is evenly coated on the substrate 23. Next, a micronized cathode material 22 having a well known diameter is evenly coated on the micronized cathode material 21 for forming an oxide cathode 40 having at least two layers of cathode material.

(4) As shown in FIG. 7(d), a micronized cathode material 21 is evenly coated on the substrate 23. Next, a micronized cathode material 22 having a well known diameter is evenly coated on the micronized cathode material 21. Next, another micronized cathode material 21 is evenly coated on the cathode material 22 having a well known diameter for forming an oxide cathode 50 having at least three layers of cathode material.

Note that in practice the invention is limited to a cathode material having one, two, or three layers as described in the above embodiments. While it is appreciated by those skilled in the art that the micronized oxide cathode as defined by the invention is that an oxide cathode formed of multiple layers of cathode material by equivalently arranging the above structure of the invention.

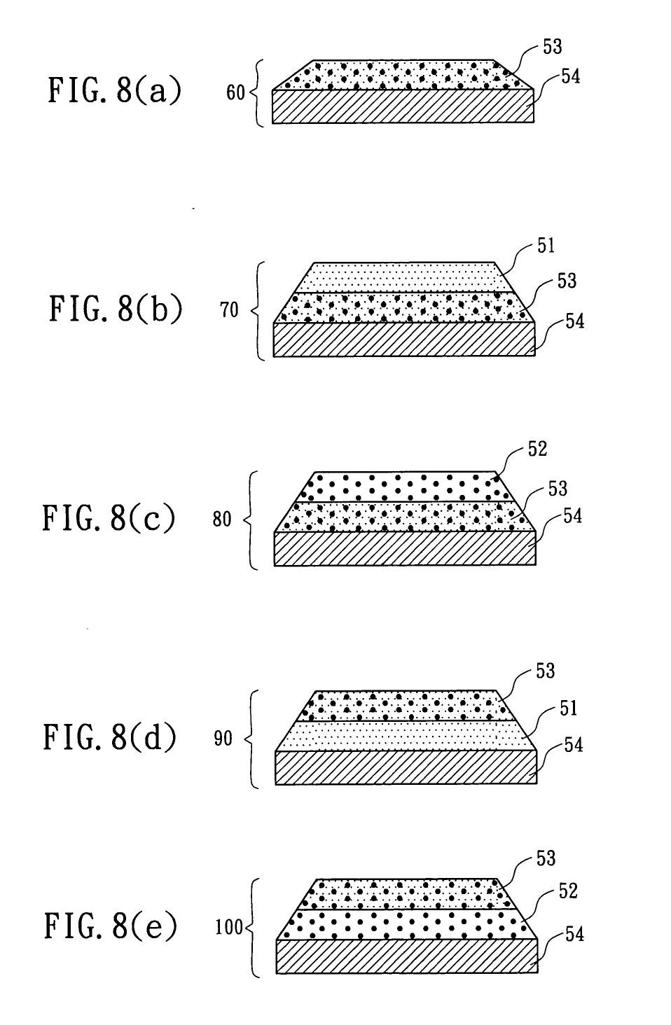

Moreover, in still other preferred embodiments of the invention it is possible of doping at least one micronized cathode material into a cathode material having the well known diameter to form a cathode material 53 having a doped diameter depending on applications. As shown in FIG. 8(a), the cathode material having a doped diameter is evenly coated on a substrate 54 to form an oxide cathode 60 of single cathode material. Alternatively, it is possible of sequentially, evenly coating the cathode material 53 having a doped diameter and a cathode material 52 having a well known diameter (or micronized cathode material 51) on a substrate 54. As a result, oxide cathodes 70, 80, 90. and 100 having at least two (or three) layers of cathode material are formed (see FIGS. 8(b), 8(c), 8(d), and 8(e)). This can effectively improve efficiency of hot electron emission of the oxide cathode by incorporating different properties of cathode materials.

In the above preferred embodiments, the invention comprises performing a micronized attrition on a cathode material containing carbonate (e.g., BaCO₃, SrCO₃, and CaCO₃) by performing a nano attrition technology, and decreasing an average diameter of particles thereof to the order of 0.455 μm (D₅₀) with a diameter distribution deviation of 0.462 μm (D₉₅−D₅=0.462 μm). We can observe the efficiency of hot electron emission of the formed oxide cathode by means of experimentation. It is found that the efficiency of hot electron emission of the micronized oxide cathode is substantially the same as that of strontium oxide cathode. Moreover, quality control of some manufacturing processes is better than that of the well known oxide cathode or strontium oxide cathode.

The invention produces three test cathodes by the above cathode material powder or particles before and after attrition in which first test cathode is characterized in that a cathode material having a well known diameter (before attrition) with a thickness hᵣ is evenly coated on the substrate. Next, a micronized cathode material (after attrition) with a thickness hₙ is evenly coated on the cathode material having the well known diameter for forming a structure having at least two layers of cathode material. A second test cathode is characterized in that a micronized cathode material (after attrition) with a thickness hₙ is evenly coated on the substrate for forming a structure having a single layer of cathode material. A third test cathode is characterized in that a cathode material having a well known diameter (before attrition) with a thickness hᵣ is evenly coated on the substrate for forming a structure having a single layer of cathode material (i.e., the well known cathode). Specifications of the above test cathodes are summarized below.

| thickness | first test cathode | second test cathode | third test cathode |
|---|---|---|---|
| hₙ | 10 μm | 35 μm | — |
| hᵣ | 60 μm | — | 70 μm |

Thereafter, the inventor mounts each of the above test cathodes in an electronic gun which is then enclosed in a color CRT. The optoelectronic property tests are performed sequentially on each CRT as follows.

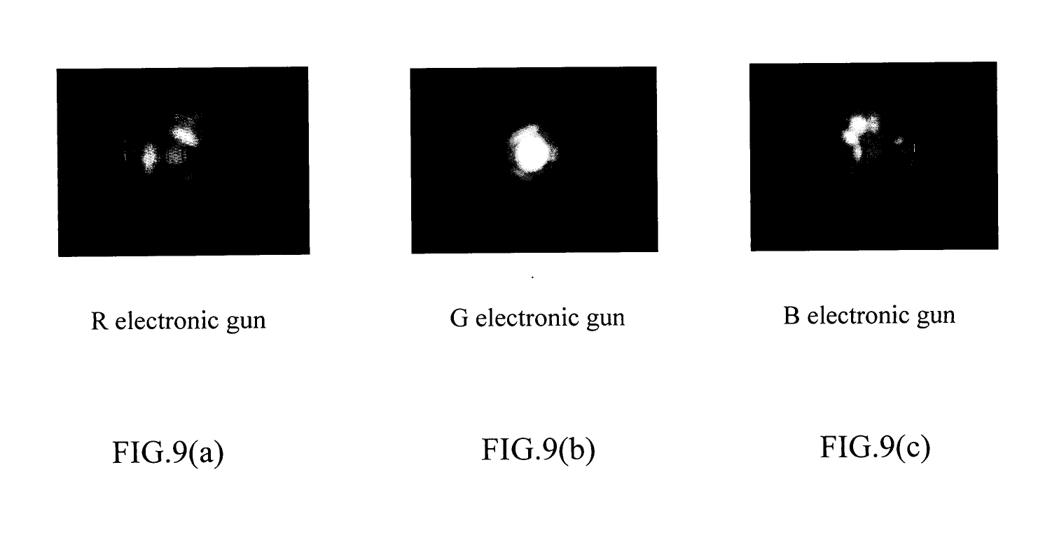

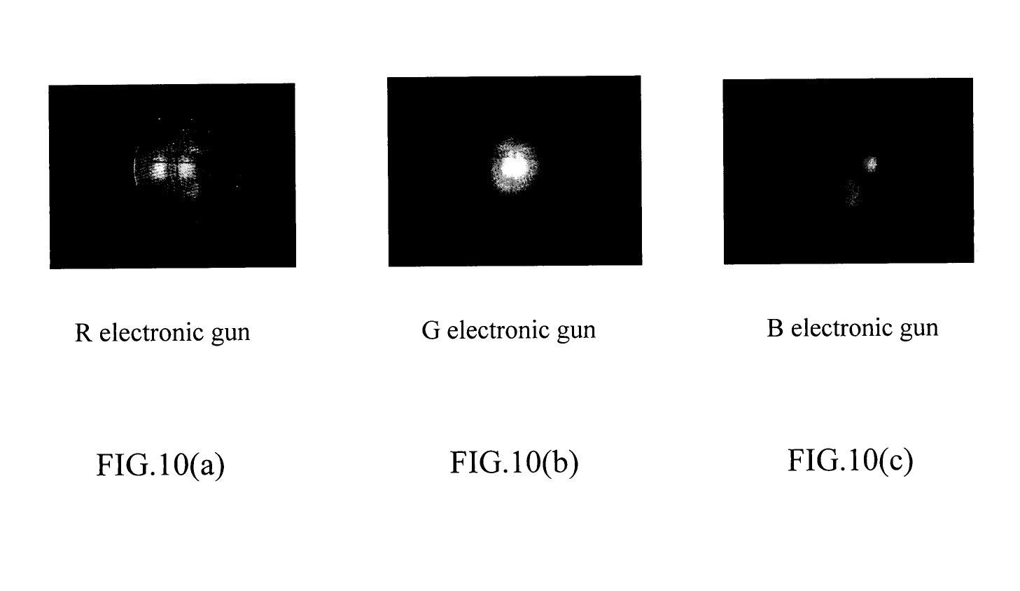

(1) Cathode condition (CC) test: It adjusts cathode current to observe processing of cathode surface by taking advantage of electron amplification principle. Phenomena such as black spots, partial dark, etc. are observed if the air escape from cathode is poor. The inventor encloses the electronic guns for the cathode test in a 15″ color CRT prior to performing the CC test. FIGS. 9(a), 9(b), and 9(c) are photographs showing the CC test results of a color CRT having a second test cathode (i.e., hₙ=35 μm). As compared with FIGS. 10(a), 10(b), and 10(c) which are photographs showing the CC test results of a color CRT having a third test cathode (i.e., hᵣ=70 μm), it is obvious that the color CRT having a second test cathode is preferred in which the CC test shows a stable electric field emission. Next, compare the color CRT having the second test cathode with the color CRT having the third test cathode. It is found that both the CC test results are the same. It is obvious that a CRT having an acceptable CC test can be produced by performing an aging process on the second test cathode.

(2) Maximum cathode current test (or called MIK test): It aims at determining the performance of the aging process, air escape condition, and cathode current emission capability. The inventor encloses a FS (flat square) type electronic gun for each of the above test cathodes in a 17″ color CRT prior to performing the MIK test. Results of the MIK test are summarized in the following table.

| | first test cathode | second test cathode | third test cathode |
|---|---|---|---|
| R | 2760 μA | 2870 μA | 2680 μA |
| G | 2760 μA | 2870 μA | 2850 μA |
| B | 2625 μA | 2890 μA | 2790 μA |
| Maximum | 35 μA | 20 μA | 170 μA |
| difference | | | |

The maximum cathode current in each of R, G, and B electronic guns of the second test cathode (i.e., hₙ=35 μm) is increased about 0.7% to 7.1% as compared with that of the third test cathode (i.e., hᵣ=70 μm). Also, from the above table it is found that the maximum difference between any two of the R, G, and B electrons of the second test cathode is 20 μA which is much smaller than 170 μA obtained from the maximum difference between any two of the R, G, and B electrons of the well known third test cathode. The test result shows that micronized cathode has a more consistent aging process under the same manufacturing conditions. As to three electron guns of the second test cathode and that of the third test cathode, there is no significant difference.

Next, the invention again encloses a F type electronic gun for each of the above test cathodes in a 17″ color CRT prior to performing the MIK test. Results of the MIK test are summarized in the following table.

| | first test cathode | second test cathode | third test cathode |
|---|---|---|---|
| R | 1073 μA | 1128 μA | 895 μA |
| G | 988 μA | 1088 μA | 875 μA |
| B | 955 μA | 1065 μA | 1005 μA |
| Maximum | 118 μA | 63 μA | 130 μA |
| difference | | | |

The maximum cathode current in each of R, G, and B electronic guns of the second test cathode (i.e., hₙ=35 μm) is increased about 6.0% to 26.0% as compared with that of the third test cathode (i.e., hᵣ=70 μm). Also, from the above table it is found that the maximum difference between any two of the R, G, and B electron guns of the second test cathode is 63 μA which is much smaller than 130 μA obtained from the maximum difference between any two of the R, G, and B electron guns of the well known third test cathode. The test result shows that micronized cathode has a more consistent aging process under the same manufacturing conditions.

(3) The maximum cathode current ratio φ MIK: The maximum cathode current ratio φis defined by formula (4) below:

$$ϕ MIK = \frac{MIK measured value}{MIK theoretical value} * 100 \% \qquad ( 4 )$$

where the obtained value is required to be more than 83%. The inventor encloses a SRF (superior real flat) type electronic gun for each of the above test cathodes in a 17″ color CRT prior to performing the φ MIK test. Results of the φ MIK test are summarized in the following table.

| | | | | third | increased |
|---|---|---|---|---|---|
| | | first test | second test | test | percentage of the |
| | | cathode | cathode | cathode | second test cathode |
| φ MIK | R | 96% | 99% | 95% | +4.2% |
| | G | 98% | 99% | 97% | +2.1% |
| | B | 97% | 100% | 98% | +2.0% |

It is seen that the maximum cathode current in each of R, G, and B electronic guns of the second test cathode (i.e., hₙ=10 μm and hᵣ=60 μm) is about the same as compared with that of the third test cathode (i.e., hᵣ=70 μm). In other words, there is no significant performance improvement. As to the increased percentage of the second test cathode (i.e., hₙ=35 μm) in the R, G, and B electrons thereof, 2.0% to 4.2% increase is obtained.

Similarly, the inventor encloses a SRF type electronic gun for each of the above test cathodes in a 17″ color CRT prior to performing the φ MIK test. Results of the φ MIK test are summarized in the following table.

| | | | | third | increased |
|---|---|---|---|---|---|
| | | first test | second test | test | percentage of the |
| | | cathode | cathode | cathode | second test cathode |
| φ MIK | R | 89.9 | 96.1 | 84.4 | 13.7% |
| | G | 88.8 | 91.5 | 87.7 | 4.3% |
| | B | 90.0 | 92.4 | 84.2 | 9.7% |

It is seen that an increased percentage of the second test cathode (i.e., hₙ=35 μm) in the R, G, and B electron guns thereof from 4.3% to 13.7% increase is obtained. As to the increased percentage of the first test cathode in the R, G, and B electron guns thereof, an acceptable increased percentage is also obtained.

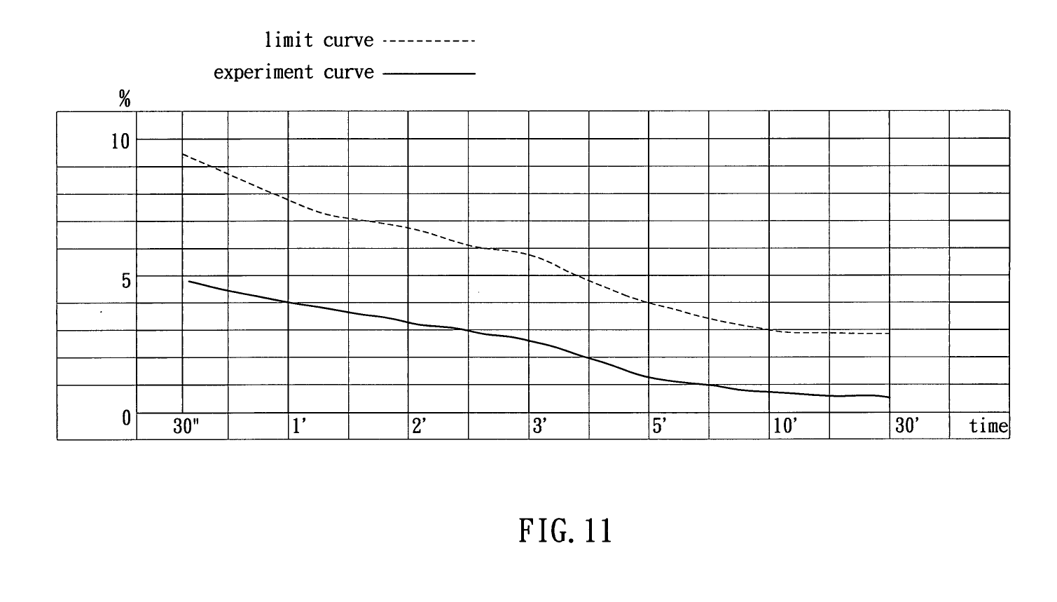

(4) Thermal strain (Ik) test: It aims at determining the stability of cathode current versus time for preventing change of color. FIG. 11 is a graph comparing a limit curve with an experiment curve in a thermal Ik test of the micronized second test cathode. It is found that the change is stabilized in 10 minutes and is found to comply with the specifications.

(5) Other cathode tests: These tests comprise COEK (cut-off potential voltage) test, RCOEK (ratio of COEK) test, and EWT (emission warm up time) test. Result shows that the distribution of the second test cathodes complies with the specifications.

In view of the above, the process of the invention comprises performing an attrition on oxide cathode particles having the well known average diameter to an average diameter of 0.09 μm to 1 μm by performing a nano attrition technology, and then coating it on a cathode substrate or doping into cathode material having the well known diameter prior to coating on the cathode substrate. As an end, current emission capability is improved effectively. Also, halo phenomenon is not susceptible of occurrence in the beams. Also, micronized cathode not only improves air escape capability and increases resistance to toxic gas but also improves the pre-focus of beam form region in the electronic gun due to more flat surface of the micronized cathode. In addition, not only focus and Moire effects of picture are significantly improved, but also yield of electronic gun or CRT is improved. Additionally, it is noted that when the micronized cathode of the invention is mounted in the electronic gun or CRT high current emission density and electron emission capability as substantially the same as that of the well known expensive strontium oxide cathode can be obtained without involvement of special modification or alteration of the existing equipment or manufacturing process. Further, characteristics about manufacturing process and quality control better than that of the well known oxide cathode or strontium oxide cathode can be obtained.

While the invention has been described by means of specific embodiments, numerous modifications and variations could be made thereto by those skilled in the art without departing from the scope and spirit of the invention set forth in the claims.

1. A process of manufacturing a micronized oxide cathode, comprising the steps of:
performing a micronized attrition on at least one cathode material for oxide cathode manufacture in order to decrease an average diameter of particles of the cathode material to about 0.09 μm to 1 μm (D₅₀);
coating the micronized cathode material on a surface of a cathode substrate; and
heating the cathode substrate in a vacuum environment by means of a heating element to produce the finished oxide cathode.

2. The process of claim 1, wherein the micronized cathode material is a cathode material containing carbonate.

3. The process of claim 2, wherein a diameter difference of particles of the micronized cathode material is from 0.25 μm to 0.55 μm (D₉₅−D₅=0.25 μm to 0.55 μm).

4. The process of claim 3, wherein a solid content of particles of the micronized cathode material is maintained in a range of about 25% to about 55%.

5. The process of claim 4, further comprising the steps of:
doping the micronized cathode material into a well known cathode material having a diameter larger than 1.7 μm for forming a cathode material having a doped diameter;
coating the cathode material having a doped diameter on a surface of the micronized cathode substrate; and
heating the cathode substrate in a vacuum environment by means of a heating element to produce the finished oxide cathode.

6. A process of manufacturing a micronized oxide cathode, comprising the steps of:
performing a micronized attrition on at least one cathode material for oxide cathode manufacture in order to decrease an average diameter of particles of the cathode material to about 0.09 μm to 1 μm (D₅₀);
doping the micronized cathode material into a well known cathode material having a diameter larger than 1.7 μm for forming a cathode material having a doped diameter;
coating the cathode material having a doped diameter on a surface of the micronized cathode substrate; and
heating the cathode substrate in a vacuum environment by means of a heating element to produce the finished oxide cathode.

7. The process of claim 6, wherein each cathode material is a cathode material containing carbonate.

8. The process of claim 7, wherein a diameter difference of particles of the micronized cathode material is from 0.25 μm to 0.55 μm (D₉₅−D₅=0.25 μm to 0.55 μm).

9. The process of claim 8, a solid content of particles of the micronized cathode material is maintained in a range of about 25% to about 55%.

10. The process of claim 9, further comprising the steps of:
coating the micronized cathode material on a surface of the cathode substrate having a doped diameter; and
heating the cathode substrate in a vacuum environment by means of a heating element to produce the finished oxide cathode.

11. A process of manufacturing a micronized oxide cathode, comprising the steps of:
coating a well known cathode material having a diameter larger than 1.7 μm on a surface of a cathode substrate;
performing a micronized attrition on the well known cathode material by means of nano attrition technology;
coating at least one micronized cathode material having an average diameter of about 0.09 μm to 1 μm (D₅₀) on a surface of the well known cathode material; and
heating the cathode substrate in a vacuum environment by means of a heating element to produce the finished oxide cathode.

12. The process of claim 11, wherein each micronized cathode material is a cathode material containing carbonate.

13. The process of claim 12, wherein a diameter difference of particles of the micronized cathode material is from 0.25 μm to 0.55 μm (D₉₅−D₅=0.25 μm to 0.55 μm).

14. The process of claim 13, wherein a solid content of particles of the micronized cathode material is maintained in a range of about 25% to about 55%.

15. A process of manufacturing a micronized oxide cathode, comprising the steps of:
coating a well known cathode material having a diameter larger than 1.7 μm on a surface of a cathode substrate;
performing a micronized attrition on the cathode material by means of nano attrition technology;
doping at least one micronized cathode material having an average diameter of about 0.09 μm to 1 μm (D₅₀) into the well known cathode material for forming a cathode material having a doped diameter;
coating the cathode material having a doped diameter on a surface of the well known cathode substrate; and
heating the cathode substrate in a vacuum environment by means of a heating element to produce the finished oxide cathode.

16. The process of claim 15, wherein each micronized cathode material is a cathode material containing carbonate.

17. The process of claim 16, wherein a diameter difference of particles of the micronized cathode material is from 0.25 μm to 0.55 μm (D₉₅−D₅=0.25 μm to 0.55 μm).

18. The process of claim 17, wherein a solid content of particles of the micronized cathode material is maintained in a range of about 25% to about 55%.
